(19) United States
(12) Patent Application Publication
(10) Pub. No.: US 2025/0246654 A1
(43) Pub. Date: Jul. 31, 2025

(54) FUEL CELL SYSTEM AND CONTROL METHOD THEREOF

(71) Applicant: HONDA MOTOR CO., LTD., Tokyo (JP)

(72) Inventor: Shuto MANIWA, Saitama (JP)

(21) Appl. No.: 19/007,628

(22) Filed: Jan. 2, 2025

(30) Foreign Application Priority Data
Jan. 25, 2024 (JP) 2024-009438

(51) Int. Cl. H01M 8/04746; H01M 8/04303; H01M 8/0432; H01M 8/0438

(52) U.S. Cl. CPC H01M 8/04753; H01M 8/04303; H01M 8/0432; H01M 8/0438

(57) ABSTRACT

A fuel cell system includes: a fuel cell that generates power by a reaction between hydrogen gas as a fuel gas and oxidant gas; a hydrogen gas supply device that supplies hydrogen gas to the fuel cell; a supply control unit that determines a supply amount and a supply timing of hydrogen gas supplied to the fuel cell; and an atmospheric pressure acquisition unit (atmospheric pressure sensor) that acquires atmospheric pressure, wherein the supply control unit supplies hydrogen gas to the fuel cell at a supply amount and a supply timing determined according to at least atmospheric pressure during soaking in which an operation of the fuel cell is stopped.

### BACKGROUND

### Technical Field

The present invention relates to a fuel cell system capable of adjusting a supply timing and a supply amount of a fuel gas during soaking according to atmospheric pressure, and a control method thereof.

### Related Art

In these years, research and development on a fuel cell that contributes to energy efficiency are conducted such that more people are able to access energy that is affordable, reliable, sustainable, and advanced.

In a fuel cell system that generates power by a fuel cell, during soaking in which an operation of the fuel cell is stopped, there is a problem that an electrode is deteriorated because oxygen remains in a system of a cathode electrode, or oxygen permeates an electrolyte membrane, reacts with hydrogen in an anode electrode system to generate hydrogen peroxide, and the electrolyte membrane is deteriorated by OH radicals generated by the generation of hydrogen peroxide. In addition, when the operation of the fuel cell is restarted, if oxygen more than a specified value is present in the anode electrode system, there is also a problem that a potential is excessively increased to deteriorate the electrode.

In order to suppress such a problem due to residual oxygen during soaking, a method has been proposed in which hydrogen gas is continuously supplied periodically during a predetermined period even during soaking, and a hydrogen partial pressure in the anode electrode system is maintained at a specified value (lower limit value) or more, thereby causing a reaction between hydrogen that has permeated the electrolyte membrane and oxygen in the cathode electrode system to consume the residual oxygen.

A fixed amount of hydrogen is often supplied at fixed time intervals during soaking, but there is also a technique of determining a supply timing of hydrogen on the basis of a physical parameter in a fuel cell stack. For example, U.S. Pat. No. 8,722,263 discloses a technique of changing a supply timing of hydrogen on the basis of a pressure or a temperature in a fuel cell stack and a technique of supplying hydrogen on the basis of a hydrogen concentration on an anode side.

### CITATION LIST

### Patent Literature

Patent Literature 1: U.S. Pat. No. 8,722,263

### SUMMARY

In the above-described conventional technique, when a supply timing and a supply amount of hydrogen during soaking of a fuel cell are determined, environmental conditions outside a fuel cell system are not considered. However, since behavior of a hydrogen partial pressure inside the fuel cell system may change depending on atmospheric pressure outside the system and outside air temperature, it may be difficult to maintain the hydrogen partial pressure in the system in an appropriate range during soaking without considering such external environmental conditions.

The present invention has been made in order to solve such a problem, and an object of the present invention is to provide a fuel cell system capable of maintaining a hydrogen partial pressure in the system in an appropriate range even when external environmental conditions change. This ultimately contributes to energy efficiency.

In order to achieve this object, a fuel cell system 1 according to claim 1 of the present invention includes: a fuel cell that generates power by a reaction between hydrogen gas as a fuel gas and oxidant gas; a hydrogen gas supply device that supplies hydrogen gas to the fuel cell; a supply control unit that determines a supply amount and a supply timing of hydrogen gas supplied to the fuel cell; and an atmospheric pressure acquisition unit that acquires atmospheric pressure, wherein the supply control unit supplies hydrogen gas to the fuel cell at a supply amount and a supply timing determined according to at least atmospheric pressure during soaking in which an operation of the fuel cell is stopped.

In this fuel cell system, the supply control unit determines the supply amount and the supply timing of hydrogen gas according to at least atmospheric pressure during soaking of the fuel cell. Here, an influence of atmospheric pressure, which is one of external environmental conditions, on a hydrogen partial pressure in the fuel cell system will be described with reference to FIG. 5. FIG. 5 is a diagram for explaining in-system gas behavior in each of a low altitude and a high altitude, that is, an environmental condition with high atmospheric pressure and an environmental condition with low atmospheric pressure.

First, as for a change in total pressure in each of an anode electrode system and a cathode electrode system (upper diagrams), hydrogen present in the anode electrode system permeates an electrolyte membrane and moves to the cathode side after soaking starts, and thus the total pressure in the anode electrode system gradually decreases. Also in the cathode electrode system, hydrogen that has permeated the electrolyte membrane reacts with oxidant gas remaining in the cathode electrode system to be consumed, and the total pressure gradually decreases.

When the low altitude and the high altitude are compared, in the high altitude condition with low atmospheric pressure, the total pressure remains at a level lower than that in the low altitude condition in both the anode electrode system and the cathode electrode system.

Next, as for a change in hydrogen concentration in the cathode electrode system (middle diagrams), the hydrogen concentration temporarily increases due to hydrogen that has permeated the electrolyte membrane from the anode side after soaking starts, and then gradually decreases as the reaction between hydrogen and the oxidant gas proceeds.

Since the hydrogen concentration in the cathode electrode system largely affects a hydrogen concentration in an exhaust gas, an upper limit value thereof is set from a viewpoint of safety.

A tendency of a change in hydrogen concentration in the cathode electrode system does not exhibit a large difference between the low altitude condition and the high altitude condition. Note that, since the total pressure in the cathode electrode system decreases in the high altitude condition, an absolute amount of the oxidant gas in the cathode electrode system also decreases. Therefore, when the same amount of hydrogen as that in the low altitude condition is supplied at the time of supplying hydrogen, an increase width of the hydrogen concentration in the cathode electrode system is also large, and the hydrogen concentration may exceed an upper limit value. Therefore, in the high altitude condition, it is necessary to make a hydrogen supply amount at one time smaller than that in the low altitude condition.

Finally, as for a change in hydrogen partial pressure in the anode electrode system (lower diagrams), hydrogen permeates the electrolyte membrane and moves to the cathode side after soaking starts, and is consumed by a reaction with the oxidant. Therefore, the hydrogen partial pressure in the anode electrode system gradually decreases.

Here, the hydrogen partial pressure in the anode electrode system needs to be maintained at a predetermined lower limit value or more from a viewpoint of suppressing deterioration of the electrode and the electrolyte membrane by consuming the oxidant gas remaining in the cathode electrode system by the reaction with hydrogen during soaking.

As described above, since the total pressure in the anode electrode system decreases in the high altitude condition, an absolute amount of hydrogen in the anode electrode system also decreases. Therefore, in the high altitude condition, a time until the hydrogen partial pressure in the anode electrode system reaches the lower limit value is shorter than that in the low altitude condition. Therefore, in the high altitude condition, it is necessary to supply hydrogen at an interval shorter than that in the low altitude condition such that the hydrogen partial pressure in the anode electrode system does not fall below the lower limit value.

On the basis of the above findings, in the fuel cell system of the present invention, since a supply amount and a supply timing of hydrogen gas can be determined according to atmospheric pressure during soaking and hydrogen gas can be supplied, a hydrogen partial pressure in the system can be maintained in an appropriate range even when atmospheric pressure as an external environmental condition changes.

An invention according to claim 2 of the present invention is the fuel cell system according to claim 1, further including an outside air temperature acquisition unit that acquires outside air temperature, wherein the supply control unit supplies hydrogen gas to the fuel cell at a supply timing determined according to at least the atmospheric pressure and the outside air temperature during soaking.

According to this configuration, the supply control unit determines the supply timing of hydrogen gas according to at least the atmospheric pressure and the outside air temperature during soaking of the fuel cell. Here, an influence of the outside air temperature, which is one of external environmental conditions, on a hydrogen partial pressure in the fuel cell system will be described with reference to FIG. 6. FIG. 6 is a diagram for explaining in-system gas behavior at each of a normal temperature and a low temperature, that is, an environmental condition with high outside air temperature and an environmental condition with low outside air temperature.

First, as for a change in total pressures in each of the anode electrode system and the cathode electrode system (upper diagrams), as in FIG. 5, after soaking starts, hydrogen in the anode electrode system permeates the electrolyte membrane and moves to the cathode side, whereby the total pressure in the anode electrode system decreases, and hydrogen and the oxidant gas react with each other in the cathode electrode system and are consumed, whereby the total pressure in the cathode electrode system also decreases.

Here, in the low temperature condition with low outside air temperature, the temperature of the gas in the system decreases faster than that in the normal temperature condition due to an influence of the outside air temperature, whereby the gas in each system is condensed and the total pressure decreases more largely.

Next, as for a change in hydrogen concentration in the cathode electrode system (middle diagrams), as in FIG. 5, the hydrogen concentration temporarily increases due to hydrogen that has permeated the electrolyte membrane from the anode side after soaking starts, and then gradually decreases as the reaction between hydrogen and the oxidant gas proceeds.

A tendency of a change in hydrogen concentration in the cathode electrode system does not exhibit a large difference between the low altitude condition and the high altitude condition.

Finally, as for a change in hydrogen partial pressure in the anode electrode system (lower diagrams), as in FIG. 5, hydrogen permeates the electrolyte membrane and moves to the cathode side after soaking starts, and is consumed by a reaction with the oxidant. Therefore, the hydrogen partial pressure in the anode electrode system gradually decreases. Here, as described above, in the low temperature condition, the total pressure in the anode electrode system more largely decreases, and therefore a decrease in hydrogen partial pressure in the anode electrode system is also larger. Therefore, in the low temperature condition, it is necessary to supply hydrogen at an interval shorter than that in the normal temperature condition such that the hydrogen partial pressure in the anode electrode system does not fall below the lower limit value.

On the basis of the above findings, in the fuel cell system having the above configuration, since a supply timing of hydrogen gas can be determined according to atmospheric pressure and outside air temperature during soaking and hydrogen gas can be supplied, a hydrogen partial pressure in the system can be maintained in an appropriate range even when the outside air temperature changes in addition to the atmospheric pressure as an external environmental condition.

An invention according to claim 3 of the present invention is the fuel cell system according to claim 2, wherein the supply control unit determines a subsequent supply amount and a subsequent supply timing of hydrogen gas according to at least atmospheric pressure and outside air temperature at the time of the previous supply of hydrogen gas during soaking.

According to this configuration, since the subsequent supply amount and the subsequent supply timing of hydrogen gas are determined according to atmospheric pressure and outside air temperature at the time of the previous supply of hydrogen gas during soaking, the supply amount and the supply timing of hydrogen gas can be determined with high responsiveness on the basis of relatively recent atmospheric pressure and outside air temperature. Therefore, the hydrogen partial pressure in the system can be maintained in an appropriate range according to changes in the atmospheric pressure and the outside air temperature.

An invention according to claim 4 of the present invention is the fuel cell system according to any one of claims 1 to 3, wherein the supply control unit determines a supply timing of hydrogen gas during soaking such that an interval from the time of the previous supply of hydrogen gas to the time of the subsequent supply of hydrogen gas is shorter as the atmospheric pressure is lower.

As described above, as the atmospheric pressure is lower, the absolute amount of hydrogen in the anode electrode system tends to be smaller, and a time until the hydrogen partial pressure in the anode electrode system reaches the lower limit value tends to be shorter. In the fuel cell system of the present configuration, since control is performed such that hydrogen gas is supplied at a shorter time interval as the atmospheric pressure is lower, the hydrogen partial pressure in the system can be maintained in an appropriate range appropriately corresponding to a change in the atmospheric pressure.

An invention according to claim 5 of the present invention is the fuel cell system according to claim 2 or 3, wherein the supply control unit determines the supply timing of hydrogen gas during soaking such that an interval from the time of the previous supply of hydrogen gas to the time of the subsequent supply of hydrogen gas is shorter as the outside air temperature is lower.

As described above, as the outside air temperature is lower, the hydrogen partial pressure in the anode electrode system decreases more due to condensation of gas, and a possibility that the hydrogen partial pressure falls below the lower limit value is higher. In the fuel cell system of the present configuration, since control is performed such that hydrogen gas is supplied at a shorter time interval as the outside air temperature is lower, the hydrogen partial pressure in the system can be maintained in an appropriate range appropriately corresponding to a change in the outside air temperature.

An invention according to claim 6 of the present invention is the fuel cell system according to claim 1, wherein the supply control unit determines the supply amount of hydrogen gas during soaking such that a hydrogen gas supply amount at one time is smaller as the atmospheric pressure is lower.

According to this configuration, the supply control unit determines the supply amount of hydrogen gas during soaking such that the hydrogen gas supply amount at one time is smaller as the atmospheric pressure is lower. Here, a change in hydrogen concentration in the cathode electrode system at the time of supply of hydrogen due to a difference in atmospheric pressure will be described with reference to FIG. 7. FIG. 7 is a diagram for explaining in-system gas behavior in each of a low altitude and a high altitude, that is, an environmental condition with high atmospheric pressure and an environmental condition with low atmospheric pressure.

First, as for a change in total pressure in each of the anode electrode system and the cathode electrode system immediately after supply of hydrogen gas during soaking (upper drawings), the total pressure in the anode electrode system temporarily largely increases due to the supply of hydrogen gas. In this example, the supply amount of hydrogen gas is determined on the basis of a gauge pressure, that is, a pressure using the atmospheric pressure as a reference. Therefore, an increase width in total pressure in the anode electrode system at the time of supply of hydrogen gas is constant regardless of whether the condition is the low altitude condition or the high altitude condition.

Next, as for a change in hydrogen concentration in the cathode electrode system (middle diagrams), since hydrogen on the anode side permeates the electrolyte membrane and enters the cathode side immediately after supply of hydrogen gas, a hydrogen concentration in the cathode electrode system temporarily largely increases.

Here, in the high altitude condition, the total pressure is small in both the anode electrode system and the cathode electrode system, and the absolute amount of gas is also small. Therefore, when hydrogen gas is supplied using the same gauge pressure width as that in the low altitude condition as a reference, an increase width of a hydrogen concentration in the cathode electrode system is larger than that in the low altitude condition, which may cause the hydrogen concentration in the system to exceed an upper limit value.

Therefore, in the high altitude condition, it is necessary to make a hydrogen supply amount at one time smaller than that in the low altitude condition.

Finally, as for a change in hydrogen partial pressure in the anode electrode system (lower diagrams), the hydrogen partial pressure in the anode electrode system temporarily increases largely by the supply of hydrogen gas, then gradually decreases because hydrogen permeates the electrolyte membrane and moves to the cathode side, and reaches an equilibrium state soon. An increase width of the hydrogen partial pressure in the anode electrode system at the time of supply of hydrogen gas is constant regardless of whether the condition is the low altitude condition or the high altitude condition.

On the basis of the above findings, in the fuel cell system having the above configuration, since the hydrogen supply amount during soaking is determined such that the hydrogen gas supply amount at one time is smaller as the atmospheric pressure is lower, the hydrogen partial pressure in the system can be more effectively maintained in an appropriate range when the atmospheric pressure as an external environmental condition changes.

A control method of a fuel cell system according to claim 7 of the present invention is a control method of a fuel cell system including: a fuel cell that generates power by a reaction between hydrogen gas and oxidant gas; a hydrogen gas supply unit that supplies hydrogen gas to the fuel cell; a supply control unit that determines a supply amount and a supply timing of hydrogen gas supplied to the fuel cell; and an atmospheric pressure acquisition unit that acquires atmospheric pressure, wherein the supply control unit executes control to supply hydrogen gas to the fuel cell at a supply amount and a supply timing determined according to at least atmospheric pressure during soaking in which an operation of the fuel cell is stopped.

By the control method of a fuel cell system of the present invention, since a supply amount and a supply timing of hydrogen gas can be determined according to atmospheric pressure during soaking and hydrogen gas can be supplied, a hydrogen partial pressure in the system can be maintained in an appropriate range even when the atmospheric pressure as an external environmental condition changes.

### BRIEF DESCRIPTION OF DRAWINGS

FIG. 1 is a schematic configuration diagram of a fuel cell vehicle on which a fuel cell system according to an embodiment of the present invention is mounted;

FIG. 2 is a flowchart illustrating hydrogen supply control processing during soaking in the fuel cell system of the example of FIG. 1;

FIG. 3 is a flowchart illustrating supply interval and supply amount determination subroutine control processing;

FIG. 4 is an explanatory diagram for explaining a transition of a hydrogen partial pressure in an anode system in hydrogen supply control during soaking according to each of the embodiment and a conventional example;

FIG. 5 is an explanatory diagram for explaining in-system gas behavior in each of a low altitude condition and a high altitude condition;

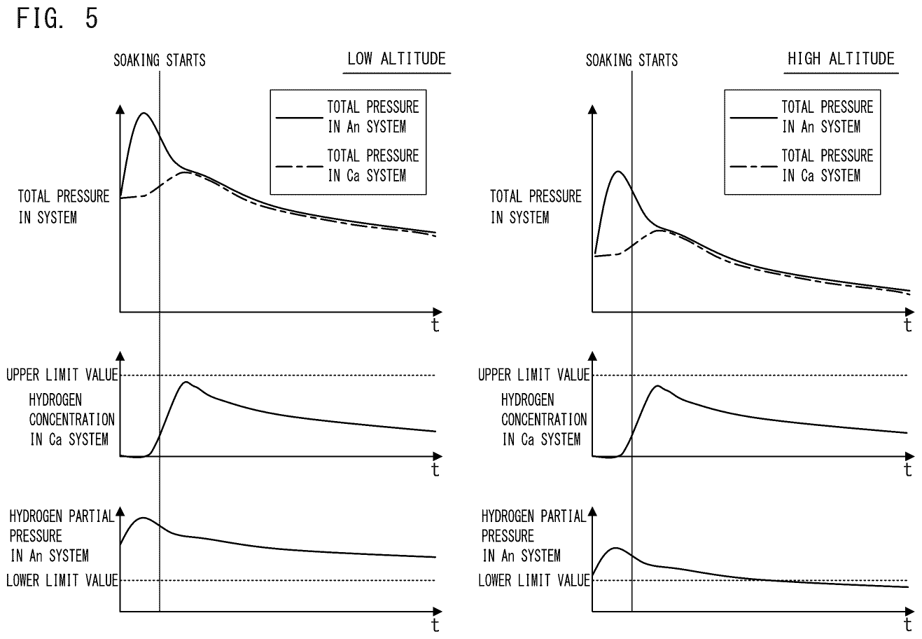

FIG. 6 is an explanatory diagram for explaining in-system gas behavior in each of a normal temperature condition and a low temperature condition; and

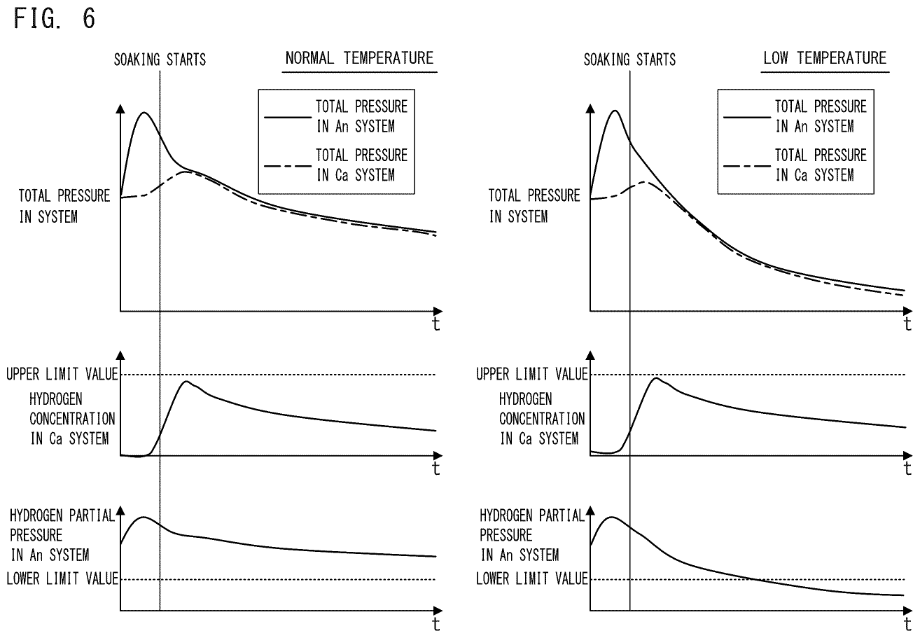

FIG. 7 is an explanatory diagram for explaining in-system gas behavior in each of a low altitude condition and a high altitude condition.

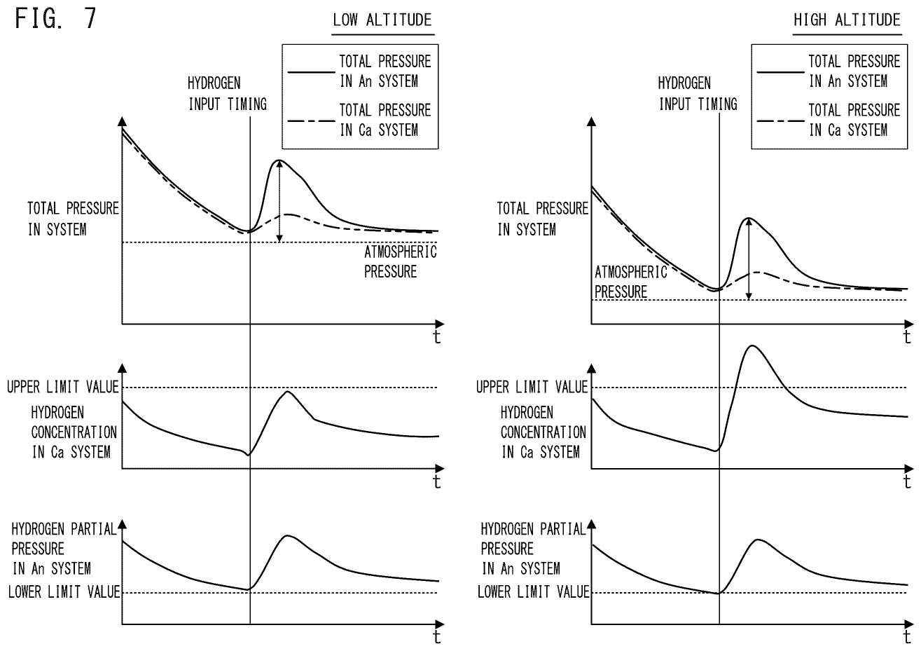

### DETAILED DESCRIPTION

Hereinafter, a preferred embodiment of a fuel cell system of the present invention will be described in detail with reference to the drawings. A fuel cell system 1 according to an exemplified embodiment is mounted on a fuel cell vehicle 100, and functions as one of power sources of the fuel cell vehicle 100. Note that the configuration described below is an example of the present invention, and the present invention is not limited thereto.

### <Configuration of Fuel Cell System 1>

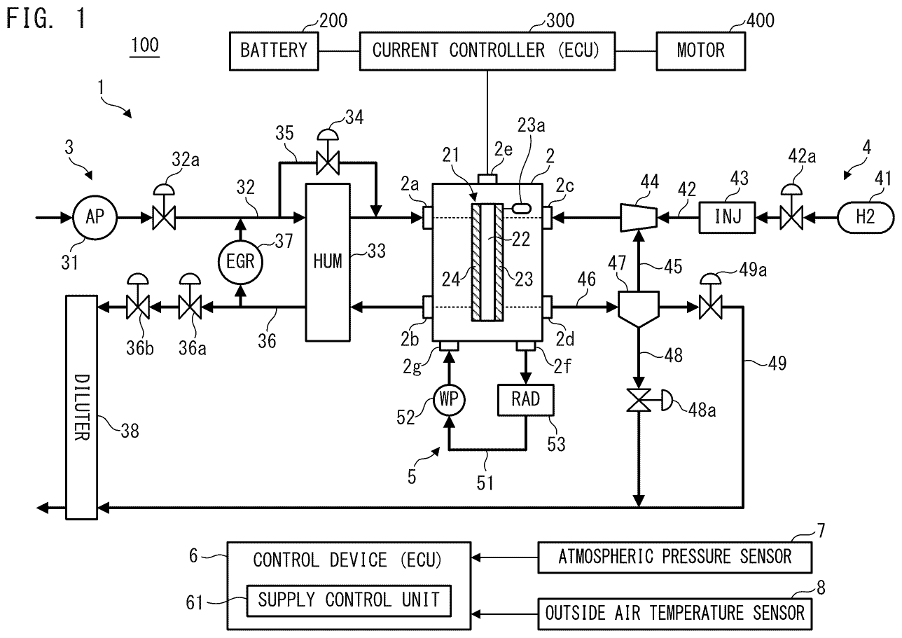

FIG. 1 is a schematic configuration diagram of the fuel cell vehicle 100 on which the fuel cell system 1 according to an embodiment is mounted. The fuel cell vehicle 100 is, for example, a fuel cell electric vehicle, and includes the fuel cell system 1, a battery 200, a current controller 300, a motor 400, and the like as illustrated in the drawing. The battery 200 may include a secondary battery, a capacitor, and the like.

The fuel cell system 1 includes a fuel cell stack (fuel cell) 2, an oxidant gas supply device 3, a hydrogen gas supply device 4, a refrigerant supply device 5, and a control device 6.

The oxidant gas supply device 3 supplies oxidant gas to the fuel cell stack 2, and the hydrogen gas supply device 4 supplies hydrogen gas as a fuel gas to the fuel cell stack 2.

The refrigerant supply device 5 cools the fuel cell stack 2 by circulating and supplying a refrigerant to the fuel cell stack 2.

The control device 6 is constituted by an electronic control unit (ECU), and operates as various control units and the like by a CPU executing a program stored in a memory as described later. The control device 6 controls the entire fuel cell system 1 (each component) through a control line (not illustrated).

The fuel cell stack 2 is a structure in which a plurality of power generation cells 21 is stacked. The fuel cell stack 2 has an oxidant gas inlet 2a, an oxidant gas outlet 2b, a hydrogen gas inlet 2c, a hydrogen gas outlet 2d, an output electrode 2e, a refrigerant outlet 2f, and a refrigerant inlet 2g.

Each power generation cell 21 in the fuel cell stack 2 has a configuration in which, for example, a solid polymer electrolyte membrane (hereinafter, also simply referred to as an electrolyte membrane) 22 that is a thin film of perfluorosulfonic acid containing moisture is sandwiched between an anode electrode 23 and a cathode electrode 24. As the electrolyte membrane 22, in addition to a fluorine-based electrolyte, a hydrocarbon-based electrolyte or the like can be used.

A pressure sensor 23a capable of measuring a total pressure (gauge pressure) in the anode electrode 23 is disposed in a sealing system of the anode electrode 23.

The fuel cell stack 2 generates power by an electrochemical reaction between oxidant gas (for example, air) supplied from the oxidant gas inlet 2a by the oxidant gas supply device 3 and hydrogen gas supplied from the hydrogen gas inlet 2c by the hydrogen gas supply device 4. The battery 200 can be charged with power generated by the fuel cell stack 2 or the power generated by the fuel cell stack 2 can be supplied to the motor 400 from the output electrode 2e through the current controller 300 under control of the control device 6.

The oxidant gas supply device 3 includes an air pump 31 that compresses and supplies air from atmosphere, and the air pump 31 is disposed in an air supply flow path 32.

In the air supply flow path 32, a humidifier 33 and a bypass flow path 35 that bypasses the humidifier 33 via a valve 34 are disposed. The air supply flow path 32 communicates with the oxidant gas inlet 2a of the fuel cell stack 2.

Note that the bypass flow path 35 and the valve 34 may be omitted.

The oxidant gas outlet 2b communicates with an air discharge flow path 36 passing through the humidifier 33. An exhaust gas recirculation (EGR) pump 37 is disposed between the air discharge flow path 36 and the air supply flow path 32.

The EGR pump 37 recirculates a part of gas discharged from the oxidant gas outlet 2b to the oxidant gas inlet 2a side.

Note that the EGR pump 37 may be omitted.

On a downstream side of the air pump 31 in the air supply flow path 32, a supply-side sealing valve 32a is disposed, and on/off of supply of air to the fuel cell stack 2 is switched by an opening and closing operation of the supply-side sealing valve 32a.

In addition, a discharge-side sealing valve 36a is disposed in the air discharge flow path 36, and a diluter 38 described later is connected to a downstream side of the discharge-side sealing valve 36a through a back pressure control valve 36b.

Note that it is also possible to dispose only a single sealing valve without separately disposing the discharge-side sealing valve 36a and the back pressure control valve 36b.

The hydrogen gas supply device 4 includes a hydrogen tank 41 that stores high-pressure hydrogen gas. The hydrogen tank 41 communicates with the hydrogen gas inlet 2c of the fuel cell stack 2 via a hydrogen supply flow path 42.

In the hydrogen supply flow path 42, a shut-off valve 42a, an injector 43, and an ejector 44 are disposed in series in this order from an upstream side.

As described later, the injector 43 specifies a supply amount and a supply timing of hydrogen gas supplied to the fuel cell stack 2 by an opening degree of the injector 43 being controlled by the control device 6. The ejector 44 sucks hydrogen gas from a circulation path 45 described later by the inside being a negative pressure.

An off gas flow path 46 communicates with the hydrogen gas outlet 2d of the fuel cell stack 2. A gas-liquid separator 47 is connected to the off gas flow path 46.

In the gas-liquid separator 47, a drain flow path 48 that discharges a liquid component, the circulation path 45 for causing a gas component to flow into the ejector 44, and a purge flow path 49 for purging a gas component to the outside are disposed.

The drain flow path 48 communicates with the diluter 38 via a valve 48a. In addition, the purge flow path 49 is connected to the diluter 38, and opening and closing thereof is switched by an operation of the purge valve 49a.

The diluter 38 mixes fuel-off gas discharged from the hydrogen gas outlet 2d of the fuel cell stack 2 and separated via the gas-liquid separator 47 with oxidant-off gas discharged from the oxidant gas outlet 2b of the fuel cell stack 2, dilutes a hydrogen concentration to a specified value or less, and then discharges the diluted gas to the outside.

The refrigerant supply device 5 includes a refrigerant flow path 51 that communicates with the refrigerant outlet 2f and the refrigerant inlet 2g of the fuel cell stack 2 and circulates and supplies a refrigerant such as pure water or ethylene glycol. In the refrigerant flow path 51, a cooling water pump 52 is disposed on the refrigerant inlet 2g side, and a radiator 53 is disposed on the refrigerant outlet 2f side.

The control device 6 is an ECU constituted by a microcomputer including a CPU, a RAM, a ROM, an I/O interface (none of which is illustrated), and the like. The control device 6 performs control such as opening and closing control of various valves in the fuel cell system 1, drive control of various auxiliary machines (the air pump 31, the cooling water pump 52, and the like), and power generation amount control of the fuel cell stack 2 performed through the current controller 300. In addition, the control device 6 controls a supply amount and a supply timing of hydrogen gas supplied to the fuel cell stack 2 by controlling an opening degree of the injector 43 while referring to a value of the pressure sensor 23a disposed in the anode electrode 23.

Note that the control device 6 may perform charge and discharge control on the battery 200 and power running and regenerative drive control on the motor 400.

In addition, an atmospheric pressure sensor 7 that detects atmospheric pressure in the vicinity of the fuel cell vehicle 100 and an outside air temperature sensor 8 that detects outside air temperature, which is air temperature in the vicinity of the fuel cell vehicle 100, are connected to the control device 6, and detection signals thereof are sequentially input to the control device 6.

The control device 6 reads and executes a program stored in the ROM or the RAM to implement a function of a supply control unit 61 described later, and the supply control unit 61 executes hydrogen supply control during soaking described later using the acquired values of the atmospheric pressure and the outside air temperature.

### <Power Generation Operation of Fuel Cell System 1>

A power generation operation of the fuel cell system 1 (a power generation operation in the fuel cell stack 2) constituted as described above will be described below.

The oxidant gas supply device 3 supplies air as oxidant gas to the air supply flow path 32 via the air pump 31. This air is humidified through the humidifier 33 or bypasses the humidifier 33 by passing through the bypass flow path 35, and then is supplied from the oxidant gas inlet 2a to the fuel cell stack 2.

On the other hand, the hydrogen gas supply device 4 supplies hydrogen gas from the hydrogen tank 41 to the hydrogen supply flow path 42 under opening degree control of the injector 43 by the control device 6. This hydrogen gas passes through the ejector 44 and is then supplied from the hydrogen gas inlet 2c to the fuel cell stack 2.

The air supplied from the oxidant gas inlet 2a to the fuel cell stack 2 is supplied to the cathode electrode 24 of each power generation cell 21, and hydrogen gas supplied from the hydrogen gas inlet 2c to the fuel cell stack 2 is supplied to the anode electrode 23 of each power generation cell 21. As a result, in each power generation cell 21, hydrogen and oxygen in air are consumed by an electrochemical reaction, and power generation is performed.

Power generated by the power generation is supplied to the battery 200 or the motor 400 through the current controller 300 under control of the control device 6.

Air (including gas after the reaction and off gas) after the reaction in the cathode electrode 24 of each power generation cell 21 is discharged from the oxidant gas outlet 2b to the air discharge flow path 36. Moisture of the discharged air is recovered when the air passes through the humidifier 33, and then the resulting air is introduced into the diluter 38.

Note that the moisture recovered by the humidifier 33 is used to humidify air passing through the air supply flow path 32, whereby the electrolyte membrane 22 in each power generation cell 21 of the fuel cell stack 2 can be maintained at a humidity suitable for power generation.

Hydrogen gas after the reaction in the anode electrode 23 of each power generation cell 21 is discharged as fuel-off gas (a partially consumed fuel gas) from the hydrogen gas outlet 2d to the off gas flow path 46. The discharged fuel-off gas is introduced into the gas-liquid separator 47 from the off gas flow path 46, and liquid moisture is separated from the fuel-off gas. Thereafter, the resulting gas is sucked into the ejector 44 via the circulation path 45.

During execution of the series of power generation operations described above, the refrigerant supply device 5 drives the cooling water pump 52 under control of the control device 6 to supply a refrigerant from the refrigerant inlet 2g to the fuel cell stack 2, and cools each power generation cell 21 by heat exchange between the refrigerant and each power generation cell 21. The refrigerant after cooling each power generation cell 21 is discharged from the refrigerant outlet 2f, then cooled by the radiator 53, and supplied to the fuel cell stack 2 again.

### <Hydrogen Supply Control During Soaking>

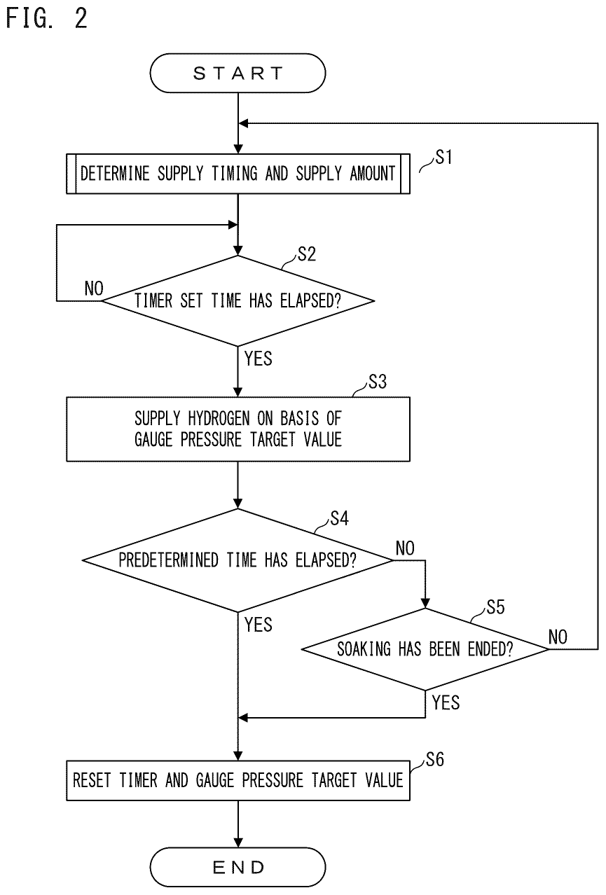

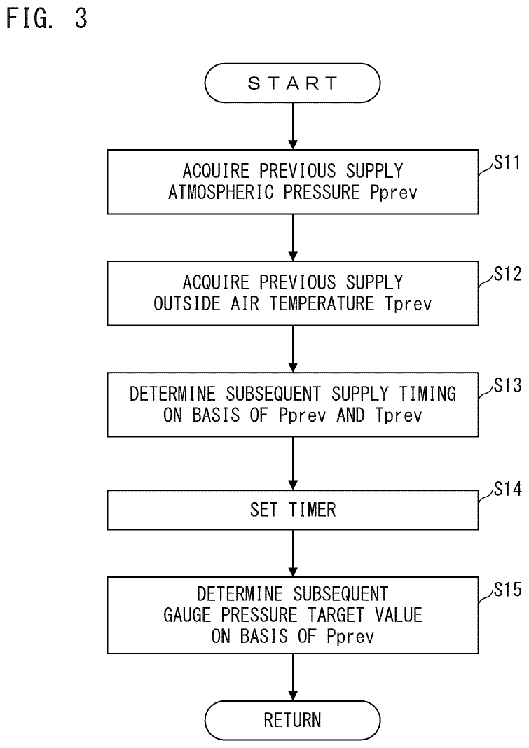

Next, hydrogen supply control during soaking and supply interval and supply amount determination control as a subroutine thereof in the fuel cell system 1 of the present embodiment will be described with reference to FIGS. 2 and 3. FIG. 2 is a flowchart illustrating hydrogen supply control processing during soaking in the present embodiment. This processing is repeatedly executed at predetermined time intervals during soaking in which a power generation operation in the fuel cell system 1 (a power generation operation in the fuel cell stack 2) is stopped.

Note that soaking in the fuel cell system 1 may be started when an ignition switch of the fuel cell vehicle 100 is turned off, or may be automatically started according to a charge state of the battery 200 or a driving state of the fuel cell vehicle 100.

First, in step 1 (described as “S1”, the same applies hereinafter), supply interval and supply amount determination control for determining a supply timing and a supply amount of hydrogen during soaking is executed.

FIG. 3 illustrates a subroutine of the supply interval and supply amount determination control. First, in step 11, a value of atmospheric pressure detected by the atmospheric pressure sensor 7 at the time of the previous supply of hydrogen gas is acquired as previous supply atmospheric pressure Pprev.

Here, the time of the previous supply of hydrogen gas refers to a time point of the previous supply of hydrogen gas after the current soaking starts, and does not refer to a time point of supply of hydrogen gas at the time of previous soaking.

When there is no time point of the previous supply of hydrogen gas, that is, when the current supply interval and supply amount determination control is executed for the first time after the current soaking starts, a value of atmospheric pressure at the time of start of soaking is exceptionally acquired as the previous supply atmospheric pressure Pprev.

In subsequent step 12, a value of outside air temperature detected by the outside air temperature sensor 8 at the time of the previous supply of hydrogen gas is acquired as previous supply outside air temperature Tprev.

Also here, the time of the previous supply of hydrogen gas refers to a time point of the previous supply of hydrogen gas after the current soaking starts, and when there is no time point of the previous supply of hydrogen gas, a value of outside air temperature at the time of start of soaking is exceptionally acquired as the previous supply outside air temperature Tprev.

In subsequent step 13, a subsequent hydrogen gas supply timing is determined on the basis of the acquired previous supply atmospheric pressure Pprev and the acquired previous supply outside air temperature Tprev. This determination may be performed by substituting the acquired values of the previous supply atmospheric pressure Pprev and the previous supply outside air temperature Tprev into a function or the like prepared in advance and deriving the subsequent hydrogen gas supply timing by calculation. Alternatively, this determination may be performed by reading a map or a table defining a corresponding hydrogen gas supply timing in advance on the basis of the previous supply atmospheric pressure Pprev, the previous supply outside air temperature Tprev, and other parameters, and searching the map or the table to acquire the subsequent hydrogen gas supply timing.

Although not illustrated, such a map or table can have a tendency to determine the hydrogen gas supply timing such that an interval from the time of the previous supply of hydrogen gas to the time of the subsequent supply of hydrogen gas is shorter as the atmospheric pressure is lower and the outside air temperature is lower. In addition to the atmospheric pressure and the outside air temperature, the hydrogen gas supply timing may be determined in consideration of pressure and temperature in the fuel cell stack 2, a hydrogen partial pressure and a hydrogen concentration in each power generation cell 21 of the fuel cell stack 2, and the like.

In subsequent step 14, a timer is set on the basis of the subsequent hydrogen gas supply timing determined in step 13, and counting is started.

In subsequent step 15, a gauge pressure target value serving as a reference of a hydrogen supply amount at the time of the subsequent supply of hydrogen is determined on the basis of the acquired previous supply atmospheric pressure Pprev, and this processing is ended. The gauge pressure target value is set as a value of gauge pressure to be reached by the total pressure in the anode electrode 23 system by supply of hydrogen gas.

The gauge pressure target value can be determined, for example, by reading a map or a table in which a value of corresponding gauge pressure (or a correction coefficient for a gauge pressure serving as a reference) is determined in advance on the basis of the previous supply atmospheric pressure Pprev or other parameters, and searching the map or the table to acquire the gauge pressure target value.

Although not illustrated, such a map or table can have a tendency to determine the gauge pressure target value such that the lower the atmospheric pressure, the smaller a subsequent hydrogen gas supply amount. In addition to the atmospheric pressure, the hydrogen gas supply amount may be determined in consideration of pressure and temperature in the fuel cell stack 2, a hydrogen partial pressure and a hydrogen concentration in each power generation cell 21 of the fuel cell stack 2, and the like.

Returning to FIG. 2, after the subsequent hydrogen gas supply timing and supply amount (gauge pressure target value) are determined in step 1, in subsequent step 2, the timer set in step 14 of FIG. 3 and started to be counted is referred to, and it is determined whether the set time has elapsed.

If the determination result is YES and the time set by the timer has elapsed, the process proceeds to subsequent step 3.

On the other hand, if the determination result is NO and the time set by the timer has not elapsed yet, the determination in step 2 is repeatedly executed until the set time elapses.

In subsequent step 3, hydrogen gas is supplied on the basis of the gauge pressure target value for the subsequent supply of hydrogen gas determined in step 1. At this time, hydrogen gas is supplied by referring to a detection value of the pressure sensor 23a disposed in the anode electrode 23 until the detection value reaches the gauge pressure target value.

In subsequent steps 4 and 5, it is determined whether or not an end condition of the hydrogen supply control during soaking is satisfied.

First, in step 4, it is determined whether or not a predetermined time set in advance has elapsed by referring to an elapsed time from start of the current soaking. This predetermined time is set as an elapsed time sufficient for determining that there is no need to supply hydrogen during soaking, and for example, can be set as a time during which it can be determined that oxidant gas remaining in the cathode electrode 24 has been sufficiently consumed by a reaction with hydrogen by the repeated execution of hydrogen supply (steps 1 to 3) during soaking.

Note that, instead of the predetermined time, the number of executions of hydrogen supply (steps 1 to 3) during soaking may be counted, and an end of hydrogen supply control during soaking may be determined if it is confirmed that hydrogen supply has been executed a predetermined number of times.

If the determination result in step 4 is YES and it is determined that execution of hydrogen supply control during soaking is no longer necessary by the lapse of the predetermined time, the process proceeds to step 6.

In step 6, the timer and the gauge pressure target value set in the supply timing and supply amount determination control (FIG. 3) in step 1 are reset, and then this control processing is ended.

On the other hand, if the determination result in step 4 is NO and it is determined that the predetermined time has not elapsed yet from start of soaking, the process proceeds to step 5.

In step 5, it is determined whether soaking of the fuel cell system 1 has been ended. If this determination result is YES and an end of soaking of the fuel cell system 1 is confirmed, the process proceeds to step 6, the timer and the gauge pressure target value are reset, and then this control processing is ended.

On the other hand, if the determination result of step 5 is NO and the fuel cell system 1 is still during soaking, the process returns to step 1, and the processing from step 1 is repeatedly executed until the end condition of step 4 or step 5 is satisfied.

As described above, in the hydrogen supply control of the fuel cell system 1 during soaking, a supply timing (interval) and a supply amount (gauge pressure target value) of hydrogen gas during soaking are changed on the basis of values of atmospheric pressure and outside air temperature acquired recently.

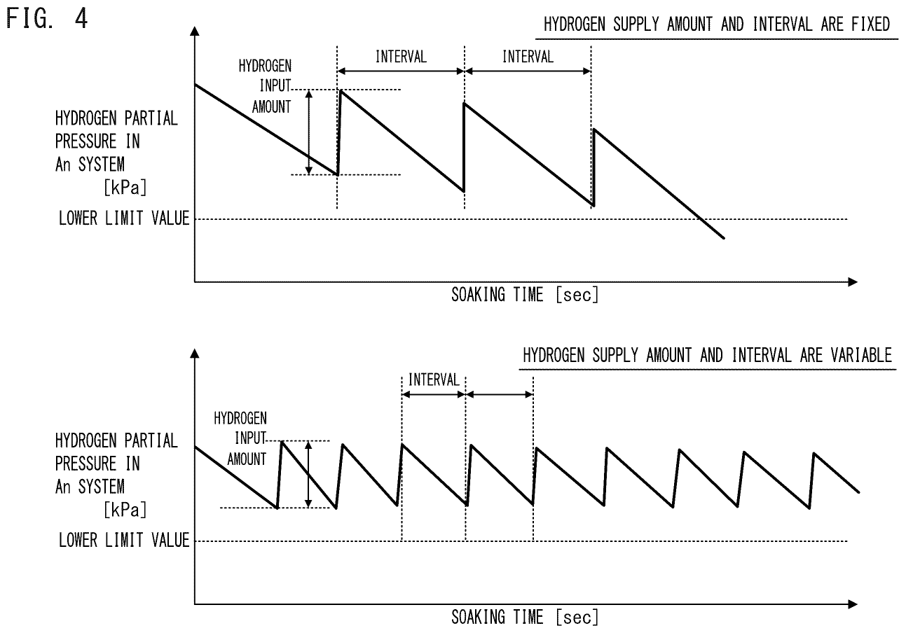

FIG. 4 is an explanatory diagram for comparing a transition of a hydrogen partial pressure in an anode electrode system in hydrogen supply control during soaking of a conventional example with a transition of a hydrogen partial pressure in an anode electrode system in hydrogen supply control during soaking of the present embodiment.

As is apparent from the drawing, in the conventional example (hydrogen supply amount and interval are fixed) in which a fixed amount of hydrogen gas is supplied at fixed time intervals, it is not possible to cope with a change in external environmental conditions. For example, in an environment where atmospheric pressure is low and outside air temperature is also low, supply of hydrogen gas does not catch up with a decrease in hydrogen partial pressure in some cases, and the hydrogen partial pressure may fall below a lower limit value.

In this case, oxidant gas remaining in the cathode electrode system during soaking cannot be consumed by a reaction with hydrogen, and deterioration of an electrode and an electrolyte membrane cannot be suppressed.

On the other hand, in the present embodiment in which a supply timing and a supply amount of hydrogen gas can be changed according to external environmental conditions (atmospheric pressure and outside air temperature), hydrogen gas can be supplied at an appropriate timing and amount even when the external environmental conditions change, and therefore a hydrogen partial pressure can be maintained in an appropriate range. This makes it possible to effectively suppress deterioration of an electrode and an electrolyte membrane.

### <Effects of Present Embodiment>

Hereinafter, effects of the present embodiment will be described.

According to the present embodiment, in hydrogen supply control of the fuel cell system 1 during soaking, a supply timing and a supply amount of hydrogen gas can be determined on the basis of atmospheric pressure, and hydrogen gas can be supplied. As a result, even when atmospheric pressure as an external environment that may affect in-system gas behavior of each power generation cell 21 of the fuel cell stack 2 changes, a hydrogen partial pressure in the fuel cell stack 2 can be maintained in an appropriate range.

In addition, in the present embodiment, in hydrogen supply control of the fuel cell system 1 during soaking, a supply timing of hydrogen gas can be determined on the basis of outside air temperature in addition to atmospheric pressure, and hydrogen gas can be supplied. As a result, even when outside air temperature as an external environment that may affect in-system gas behavior of each power generation cell 21 of the fuel cell stack 2 changes, a hydrogen partial pressure in the fuel cell stack 2 can be maintained in an appropriate range.

In addition, since the atmospheric pressure and the outside air temperature referred to in the hydrogen supply control during soaking are atmospheric pressure and outside air temperature at the time of the previous supply of hydrogen gas (or atmospheric pressure and outside air temperature at the time of start of soaking), the supply amount and the supply timing of hydrogen gas can be determined with high responsiveness on the basis of relatively recent atmospheric pressure and outside air temperature.

In addition, in the hydrogen supply control during soaking (supply timing and supply amount determination control subroutine), since the hydrogen gas is supplied at shorter time intervals as atmospheric pressure is lower and outside air temperature is lower, a hydrogen partial pressure in the system can be maintained in a more appropriate range according to changes in the atmospheric pressure and the outside air temperature.

In addition, in the hydrogen supply control during soaking (supply timing and supply amount determination control subroutine), since the supply amount in supply of hydrogen gas at one time is set smaller as atmospheric pressure is lower, a hydrogen partial pressure in the system can be more effectively maintained in an appropriate range according to a change in atmospheric pressure.

Note that the present invention is not limited to the described embodiment, and can be implemented in various modes. In addition, the detailed configuration can be changed as appropriate within the scope of the gist of the present invention.

What is claimed is:

1. A fuel cell system comprising:
a fuel cell that generates power by a reaction between hydrogen gas as a fuel gas and oxidant gas;
a hydrogen gas supply device that supplies the hydrogen gas to the fuel cell;
a supply control unit that determines a supply amount and a supply timing of the hydrogen gas supplied to the fuel cell; and
an atmospheric pressure acquisition unit that acquires atmospheric pressure, wherein
the supply control unit supplies the hydrogen gas to the fuel cell at the supply amount and the supply timing determined according to at least the atmospheric pressure during soaking in which an operation of the fuel cell is stopped.

2. The fuel cell system according to claim 1, further comprising an outside air temperature acquisition unit that acquires outside air temperature, wherein
the supply control unit supplies the hydrogen gas to the fuel cell at the supply timing determined according to at least the atmospheric pressure and the outside air temperature during the soaking.

3. The fuel cell system according to claim 2, wherein the supply control unit determines a subsequent supply amount and a subsequent supply timing of the hydrogen gas according to at least the atmospheric pressure and the outside air temperature at the time of previous supply of the hydrogen gas during the soaking.

4. The fuel cell system according to claim 1, wherein the supply control unit determines the supply timing of the hydrogen gas during the soaking such that an interval from a time of previous supply of the hydrogen gas to a time of subsequent supply of the hydrogen gas is shorter as the atmospheric pressure is lower.

5. The fuel cell system according to claim 2, wherein the supply control unit determines the supply timing of the hydrogen gas during the soaking such that an interval from a time of previous supply of the hydrogen gas to a time of subsequent supply of the hydrogen gas is shorter as the outside air temperature is lower.

6. The fuel cell system according to claim 1, wherein the supply control unit determines the supply amount of the hydrogen gas during the soaking such that a hydrogen gas supply amount at one time is smaller as the atmospheric pressure is lower.

7. A control method of a fuel cell system comprising:
a fuel cell that generates power by a reaction between hydrogen gas and oxidant gas;
a hydrogen gas supply unit that supplies the hydrogen gas to the fuel cell;
a supply control unit that determines a supply amount and a supply timing of the hydrogen gas supplied to the fuel cell; and
an atmospheric pressure acquisition unit that acquires atmospheric pressure, wherein
the supply control unit executes control to supply the hydrogen gas to the fuel cell at the supply amount and the supply timing determined according to at least the atmospheric pressure during soaking in which an operation of the fuel cell is stopped.
